(19) United States
(12) Patent Application Publication
(10) Pub. No.: US 2026/0225371 A1
(43) Pub. Date: Aug. 6, 2026

(54) LIQUID CONSUMING DEVICE INCLUDING FIRST AND SECOND CHAMBERS WITH VISUALLY DISTINGUISHABLE VOLUME DIFFERENCE

(71) Applicant: BROTHER KOGYO KABUSHIKI KAISHA, Nagoya (JP)

(72) Inventors: Fumiya NAKAMURA, Nagoya (JP); Masahiro HAYASHI, Anjo (JP)

(73) Assignee: BROTHER KOGYO KABUSHIKI KAISHA, Nagoya (JP)

(21) Appl. No.: 19/457,890

(22) Filed: Jan. 23, 2026

(30) Foreign Application Priority Data
Jan. 31, 2025 (JP) 2025-015371

(51) Int. Cl. B41J 2/175

(52) U.S. Cl. CPC B41J 2/17566; B41J 2/17506; B41J 2/17513; B41J 2/17523; B41J 2/17553; B41J 2002/17573

(57) ABSTRACT

A liquid consuming device includes a housing, a liquid consuming part, a first tank, and a second tank. The first tank includes: a first liquid chamber for storing first liquid; a first wall through which a liquid level of the first liquid is visible; and a first inlet port. The second tank includes: a second liquid chamber for storing second liquid; a second wall through which a liquid level of the second liquid is visible; and a second inlet port. The first tank has a smaller volume than the second tank. In a left-right direction in which the first tank and the second tank are arranged, the first wall has a smaller dimension than the second wall. A region in a front-rear direction of the second liquid chamber where the second inlet port is located has a smaller dimension than the dimension of the second wall in the left-right direction.

### REFERENCE TO RELATED APPLICATIONS

This application claims priority from Japanese Patent Application No. 2025-015371 filed on January 31, 2025. The entire content of the priority application is incorporated herein by reference.

### BACKGROUND ART

A known device has a structure where a plurality of ink tanks, each having an inlet port for ink replenishment, are arranged horizontally. Among the plurality of ink tanks, the ink tank storing black ink has a larger cross-sectional area than the other ink tanks.

### SUMMARY

In the device with the above-described structure, a liquid level of the ink stored in each ink tank is visible from a front side of the device. However, the ink tank storing black ink has the same left-right dimension as the other ink tanks storing ink of other colors different from black. Accordingly, when a user views the ink tanks from the front side of this device, the user cannot intuitively recognize that the ink tank storing black ink has a larger volume than the other ink tanks storing ink other than black ink. Nevertheless, in a case where the ink tank storing black ink has a larger left-right dimension than the other ink tanks, the sum of the left-right dimensions of the plurality of ink tanks would increase. As a result, the ink tanks would occupy a larger space inside a housing of the device.

In view of the foregoing, it is an object of the present disclosure to provide a structure that enables a user, who is looking at a first tank and a second tank, to intuitively recognize which one of the first tank and the second tank has a larger volume, without increasing a space occupied by the first tank and the second tank inside a housing of a device.

In order to attain the above and other object, the present disclosure provides a liquid consuming device including a housing, a liquid consuming part, a first tank, and a second tank. The first tank is arranged inside the housing. The first tank includes: a first liquid chamber, a first wall, and a first inlet port. The first liquid chamber is configured to store first liquid to be supplied to the liquid consuming part. The first liquid chamber has a first volume. A liquid level of the first liquid stored in the first liquid chamber is visible through the first wall. The first wall defines the first liquid chamber. The first inlet port provides communication between the first liquid chamber and an outside of the first tank. The second tank is arranged inside the housing. The first tank and the second tank are arranged in a left-right direction. The second tank includes a second liquid chamber, a second wall, and a second inlet port. The second liquid chamber is configured to store second liquid to be supplied to the liquid consuming part. The second liquid chamber has a second volume. A liquid level of the second liquid stored in the second liquid chamber is visible through the second wall. The second wall defines the second liquid chamber. The second inlet port provides communication between the second liquid chamber and an outside of the second tank. The first volume of the first liquid chamber is smaller than the second volume of the second liquid chamber. The first wall has a first dimension in the left-right direction that is smaller than a second dimension of the second wall in the left-right direction. The second liquid chamber has a specific region where the second inlet port is located. The specific region of the second liquid chamber has a third dimension in the left-right direction that is smaller than the second dimension.

With the above structure, a user can intuitively recognize which one of the first volume of the first liquid chamber and the second volume of the second liquid chamber is greater than the other by looking at the first dimension of the first wall and the second dimension of the second wall. Since the third dimension is smaller than the second dimension, the first tank and the second tank occupy a smaller space inside the housing in the left-right direction to have a smaller dimension in the left-right direction than otherwise.

According to another aspect, the present disclosure also provides a liquid consuming device including a housing, a liquid consuming part, a first tank, and a second tank. The first tank is arranged inside the housing. The first tank includes: a first liquid chamber, a first wall, and a first inlet port. The first liquid chamber is configured to store first liquid to be supplied to the liquid consuming part. The first liquid chamber has a first volume. A liquid level of the first liquid stored in the first liquid chamber is visible through the first wall. The first wall defines the first liquid chamber. The first inlet port provides communication between the first liquid chamber and an outside of the first tank. The second tank is arranged inside the housing. The first tank and the second tank are arranged in a left-right direction. The second tank includes a second liquid chamber, a second wall, and a second inlet port. The second liquid chamber is configured to store second liquid to be supplied to the liquid consuming part. The second liquid chamber has a second volume. A liquid level of the second liquid stored in the second liquid chamber is visible through the second wall. The second wall defines the second liquid chamber. The second inlet port provides communication between the second liquid chamber and an outside of the second tank. The first volume of the first liquid chamber is smaller than the second volume of the second liquid chamber. The first wall has a first area visible from an outside of the housing and the second wall has a second area visible from the outside of the housing. The first area has a first dimension in the left-right direction that is smaller than a second dimension of the second area in the left-right direction. The second liquid chamber has a specific region where the second inlet port is located. The specific region of the second liquid chamber has a third dimension in the left-right direction. The first liquid chamber has a specific region where the first inlet port is located. The specific region of the first liquid chamber has a fourth dimension in the left-right direction that is equal to the third dimension.

With the above structure, a user can intuitively recognize which one of the first volume of the first liquid chamber and the second volume of the second liquid chamber is greater than the other by looking at the first dimension of the first area and the second dimension of the second area. Since the third dimension and the fourth dimension are equal to each other, the first tank and the second tank occupy a smaller space inside the housing in the left-right direction to have a smaller dimension in the left-right direction.

According to still another aspect, the present disclosure also provides a liquid consuming device including a housing, a liquid consuming part, a first tank, and a second tank. The first tank is arranged inside the housing. The first tank includes: a first liquid chamber, a first wall, and a first inlet port. The first liquid chamber is configured to store first liquid to be supplied to the liquid consuming part. The first liquid chamber has a first volume. A liquid level of the first liquid stored in the first liquid chamber is visible through the first wall. The first wall defines the first liquid chamber. The first inlet port provides communication between the first liquid chamber and an outside of the first tank. The second tank is arranged inside the housing. The first tank and the second tank are arranged in a left-right direction. The second tank includes a second liquid chamber, a second wall, and a second inlet port. The second liquid chamber is configured to store second liquid to be supplied to the liquid consuming part. The second liquid chamber has a second volume. A liquid level of the second liquid stored in the second liquid chamber is visible through the second wall. The second wall defines the second liquid chamber. The second inlet port provides communication between the second liquid chamber and an outside of the second tank. The first volume of the first liquid chamber is smaller than the second volume of the second liquid chamber. The first wall has a first area visible from an outside of the housing and the second wall has a second area visible from the outside of the housing. The first area has a first dimension in the left-right direction and the second area has a second dimension in the left-right direction. A ratio of the first dimension to the second dimension is equal to a ratio of the first volume to the second volume.

With the above structure, a user can intuitively recognize the ratio of the first volume of the first liquid chamber to the second volume of the second liquid chamber by looking at the first dimension of the first wall and the second dimension of the second wall.

### BRIEF DESCRIPTION OF DRAWINGS

FIG. 1 is a perspective external view of a multifunction peripheral 10.

FIG. 2 is a vertical cross-sectional view schematically illustrating an internal configuration of a printer portion 11 of the multifunction peripheral 10.

FIG. 3 is a plan view illustrating a layout of a carriage 23 and an ink tank 100.

FIG. 4 is a front perspective view of the ink tank 100.

FIG. 5 is a cross-sectional view illustrating a chamber layout in the ink tank 100 taken along a line V-V in FIG. 4.

FIG. 6 is a plan view schematically illustrating the ink tank 100.

FIG. 7A is a plan view schematically illustrating a chamber layout in an ink tank 100A.

FIG. 7B is a plan view schematically illustrating a chamber layout in an ink tank 100B.

FIG. 8 is a plan view schematically illustrating a chamber layout in an ink tank 100C.

FIG. 9 is a plan view schematically illustrating a chamber layout in an ink tank 100D according to a fourth modification to the first embodiment.

FIG. 10 is a front perspective view illustrating an ink tank 200 and a tank cover 130 therefor.

FIG. 11 is a plan view schematically illustrating the ink tank 200 and the tank cover 130 therefor.

FIG. 12 is a plan view schematically illustrating an ink tank 200Aand a tank cover 130A therefor.

### DESCRIPTION

Hereinafter, embodiments of the present disclosure will be described while referring to the accompanying drawings.

In the present embodiments, an up-down direction corresponds to the vertical direction, and a front-rear direction and a left-right direction both correspond to a horizontal direction.

Further, with respect to a multifunction peripheral 10 according to the embodiments, the up-down direction will be referred to assuming that the multifunction peripheral 10 is placed in an operable state or posture; the front-rear direction will be referred to assuming that a surface of the multifunction peripheral 10 having an opening 13 is defined as a front surface of the multifunction peripheral 10; and the left-right direction will be referred to assuming that the multifunction peripheral 10 is viewed from its front side.

### First Embodiment

### Overall Configuration of Multifunction Peripheral 10

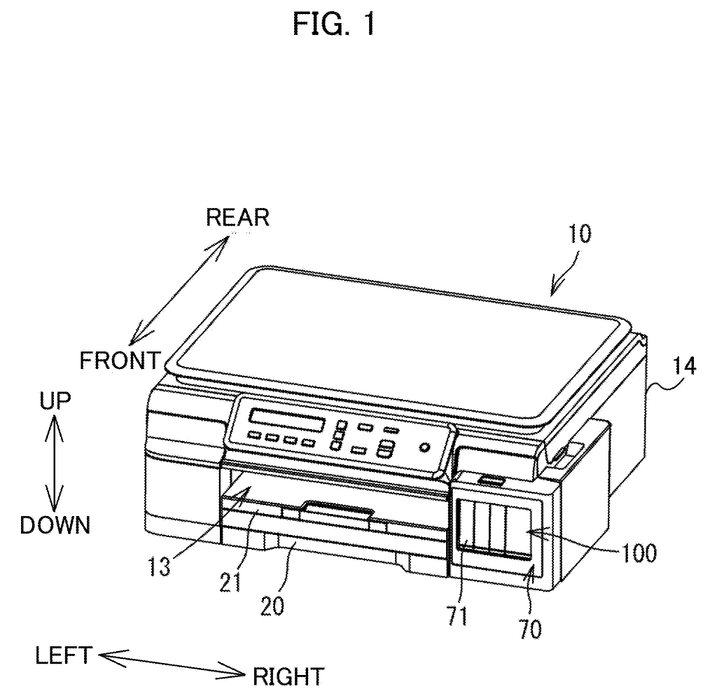

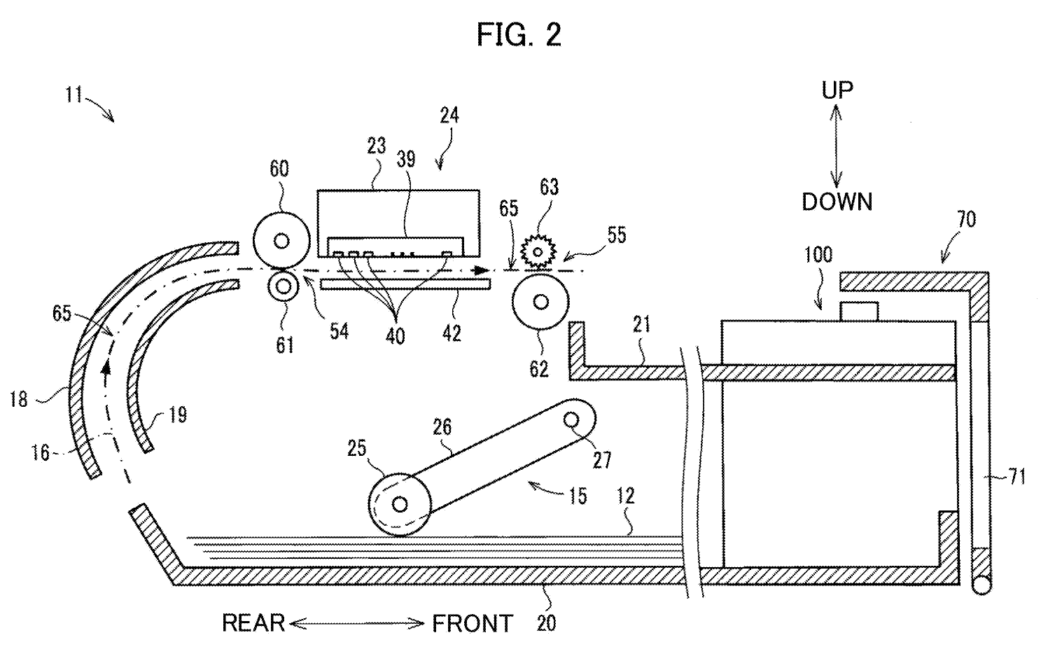

As illustrated in FIG. 1, the multifunction peripheral 10 has an outer shape of a substantially rectangular parallelepiped. The multifunction peripheral 10 has a housing 14 in which a printer portion 11 is disposed (see FIG. 2). The printer portion 11 is positioned in a lower internal portion of the housing 14. The printer portion 11 is configured to record an image on a sheet 12 in accordance with an inkjet recording method.

As illustrated in FIG. 2, the printer portion 11 includes a sheet pick-up unit 15, a sheet tray 20, a discharge tray 21, a conveying roller unit 54, a recording portion 24, a discharge roller unit 55, a platen 42, and an ink tank 100. The multifunction peripheral 10 has various functions such as a facsimile function and a printing function. The printer portion 11 is an example of “liquid consuming device” of the disclosure.

### Sheet Tray 20 and Discharge Tray 21

As illustrated in FIG. 1, the multifunction peripheral 10 has, on its front surface, an opening 13 located in a central portion in the left-right direction. The sheet tray 20 is movable in the front-rear direction relative to the housing 14. The sheet tray 20 is configured to support a plurality of the sheets 12 in a stacked state.

The discharge tray 21 is positioned above the sheet tray 20. The discharge tray 21 is movable in the front-rear direction together with the sheet tray 20. The discharge tray 21 is configured to support the sheets 12 discharged by the discharge roller unit 55. A user can move the sheet tray 20 and the discharge tray 21 in the front-rear direction, relative to the housing 14, through the opening 13.

### Sheet Pick-up Unit 15

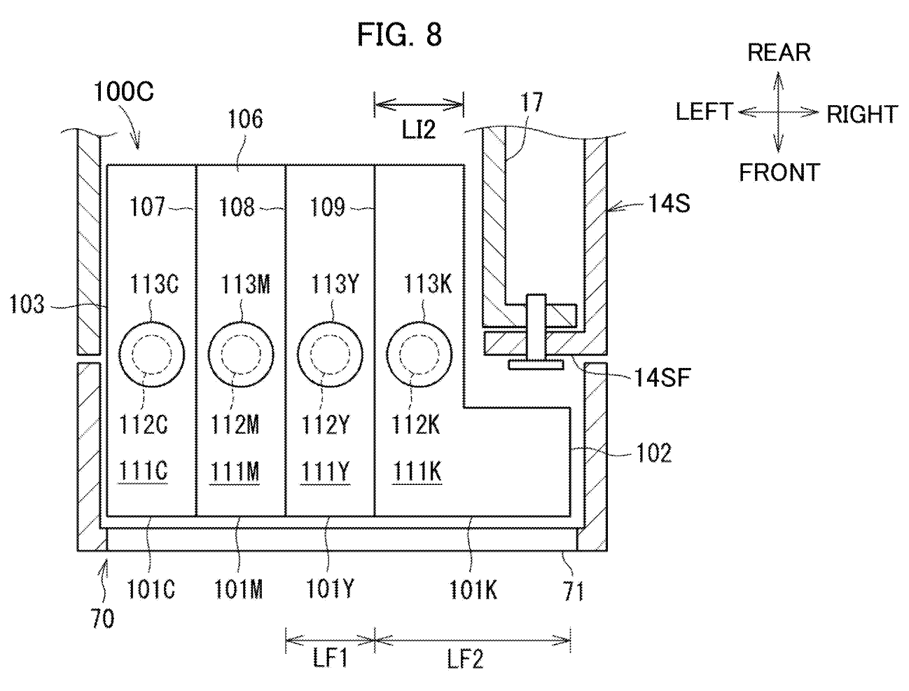

The sheet pick-up unit 15 is configured to feed the sheets 12 supported on the sheet tray 20 one by one to a conveying path 65. As illustrated in FIG. 2, the sheet pick-up unit 15 includes a pick-up roller 25, a pick-up arm 26, and a shaft 27. The pick-up roller 25 is rotatably supported by a free end portion of the pick-up arm 26. The pick-up roller 25 is configured to rotate in response to receiving a driving force from a conveyor motor (not illustrated), thereby feeding the sheets 12, one by one, in a conveying direction 16. The shaft 27 is supported by a frame 17 (illustrated in FIG. 8) of the printer portion 11. The pick-up arm 26 is supported by the shaft 27 so as to be pivotally movable about an axis of the shaft 27. The pick-up arm 26 is urged, by its own weight or by a resiliently urging force of a spring (not illustrated), such that the pick-up arm 26 is pivotable toward the sheet tray 20.

### Conveying Path 65

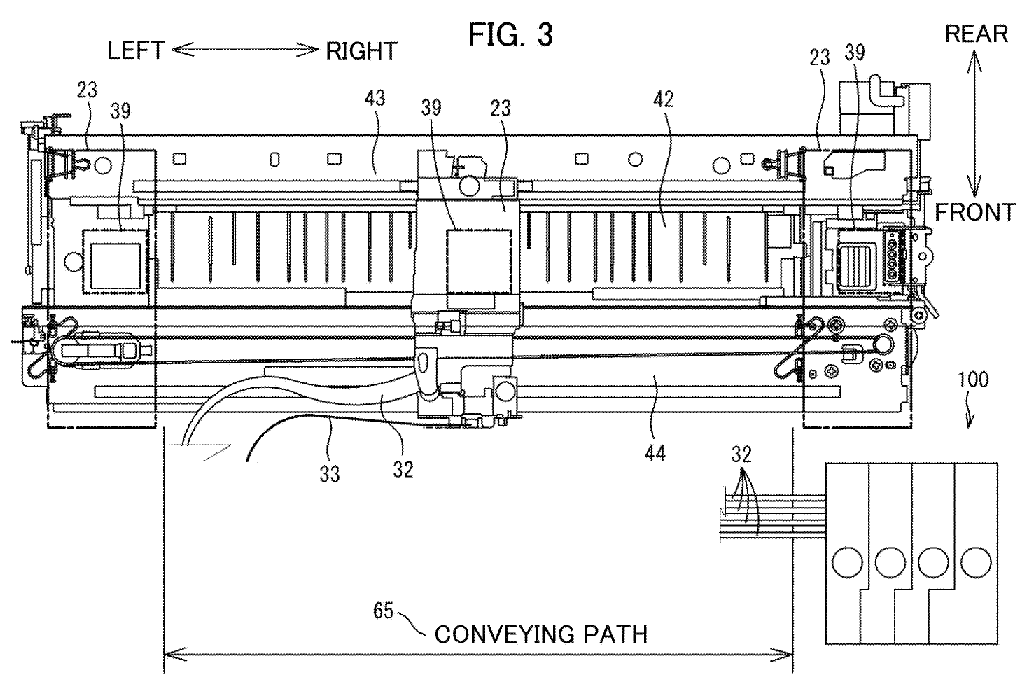

The conveying path 65 is defined inside the printer portion 11. As illustrated in FIG. 2, the conveying path 65 is a space defined by, for example, an outer guide member 18 and an inner guide member 19 arranged to oppose each other with a predetermined gap therebetween. The conveying path 65 extends upward from a rear end portion of the sheet tray 20, and then is curved in a U-turn to extend toward the front. The conveying path 65 then extends to the discharge tray 21 through a space between the recording portion 24 and the platen 42. As illustrated in FIGS. 2 and 3, a portion of the conveying path 65 between the conveying roller unit 54 and the discharge roller unit 55 is located substantially in a central portion of the multifunction peripheral 10 in the left-right direction, and extends in the front-rear direction. The conveying direction 16 of each sheet 12 in the conveying path 65 is indicated by a dotted-chain-line arrow in FIG. 2.

### Conveying Roller Unit 54

As illustrated in FIG. 2, the conveying roller unit 54 is positioned upstream of the recording portion 24 in the conveying direction 16. The conveying roller unit 54 includes a conveying roller 60 and a pinch roller 61 arranged to oppose each other in the up-down direction. The conveying roller 60 is configured to rotate upon receipt of a driving force of the conveyor motor. The pinch roller 61 is configured to rotate following the rotation of the conveying roller 60. The conveying roller 60 and the pinch roller 61 are configured to convey each sheet 12 in the conveying direction 16 while nipping the sheet 12 therebetween.

### Discharge Roller Unit 55

As illustrated in FIG. 2, the discharge roller unit 55 is positioned downstream of the recording portion 24 in the conveying direction 16. The discharge roller unit 55 includes a discharging roller 62 and a spur 63 arranged to oppose each other in the up-down direction. The discharging roller 62 is configured to rotate by the driving force of the conveyor motor. The spur 63 is configured to rotate following the rotation of the discharging roller 62. The discharging roller 62 and the spur 63 are configured to convey each sheet 12 in the conveying direction 16 while nipping the sheet 12 therebetween.

### Recording Portion 24

As illustrated in FIG. 2, the recording portion 24 is positioned between the conveying roller unit 54 and the discharge roller unit 55 in the conveying direction 16. The recording portion 24 faces the platen 42 across the conveying path 65 in the up-down direction. The recording portion 24 includes a carriage 23 and a recording head 39. The recording portion 24 is an example of “liquid consuming part” of the disclosure.

As illustrated in FIG. 3, the carriage 23 is supported by guide rails 43 and 44. The guide rails 43 and 44 are supported by the frame 17 of the printer portion 11. The guide rails 43 and 44 are spaced apart from each other in the front-rear direction. The guide rail 44 includes a known belt mechanism. The belt mechanism is configured to be driven by a carriage-driving motor (not illustrated). The carriage 23 is coupled to the belt mechanism. The carriage 23 is configured to move reciprocatingly in the left-right direction in response to circular movement of the belt mechanism. The carriage 23 is configured to move, in the left-right direction, within a prescribed range which is indicated by one-dotted chain lines in FIG. 3.

As illustrated in FIG. 3, the recording head 39 is connected to the ink tank 100 through four ink tubes 32. The recording head 39 is electrically connected, through a flexible flat cable 33, to a control board (not illustrated) on which a controller (not illustrated) is surface-mounted. The four ink tubes 32 are used to supply ink stored in the ink tank 100 to the recording head 39. Specifically, the four ink tubes 32 respectively correspond to four colors of ink, i.e., black, magenta, cyan, and yellow. The flexible flat cable 33 is configured to transmit control signals outputted by the controller to the recording head 39.

As illustrated in FIG. 2, the recording head 39 is mounted on the carriage 23. The recording head 39 has a lower surface formed with a plurality of nozzles 40. The recording head 39 is configured to eject ink as minute ink droplets through the nozzles 40. While the carriage 23 moves reciprocatingly, the recording head 39 ejects ink droplets, through the nozzles 40, onto a sheet 12 supported by the platen 42, thereby recording an image on the sheet 12.

### Platen 42

As illustrated in FIGS. 2 and 3, the platen 42 is positioned between the conveying roller unit 54 and the discharge roller unit 55 in the conveying direction 16. The platen 42 is arranged to oppose the recording portion 24 in the up-down direction. The platen 42 supports a sheet 12 being conveyed by the conveying roller unit 54 from below.

### Ink Tank 100

As illustrated in FIG. 1, the ink tank 100 is positioned in an interior of the multifunction peripheral 10. The ink tank 100 is fixed to the multifunction peripheral 10 such that a user cannot remove the ink tank 100 easily from the multifunction peripheral 10. An opening is formed at a right end portion of the front surface of the housing 14 of the multifunction peripheral 10. The ink tank 100 is positioned rearward of the opening. The housing 14 includes a cover 70 for covering the opening.

The cover 70 is pivotally movable about a pivot axis extending in the left-right direction at a lower end of the cover 70. The cover 70 is pivotable between a closed position for covering the opening and an open position for exposing the opening to an outside of the multifunction peripheral 10. The cover 70 has a through-hole at a central portion thereof, the through-hole extending throughout a thickness of the cover 70. The through-hole is covered by a transparent member 71. The entire width of a front wall 101 of the ink tank 100 in the left-right direction is visible from outside of the multifunction peripheral 10 through the transparent member 71 when the cover 70 is in the closed position. The through-hole of the cover 70 may not be covered by the transparent member 71.

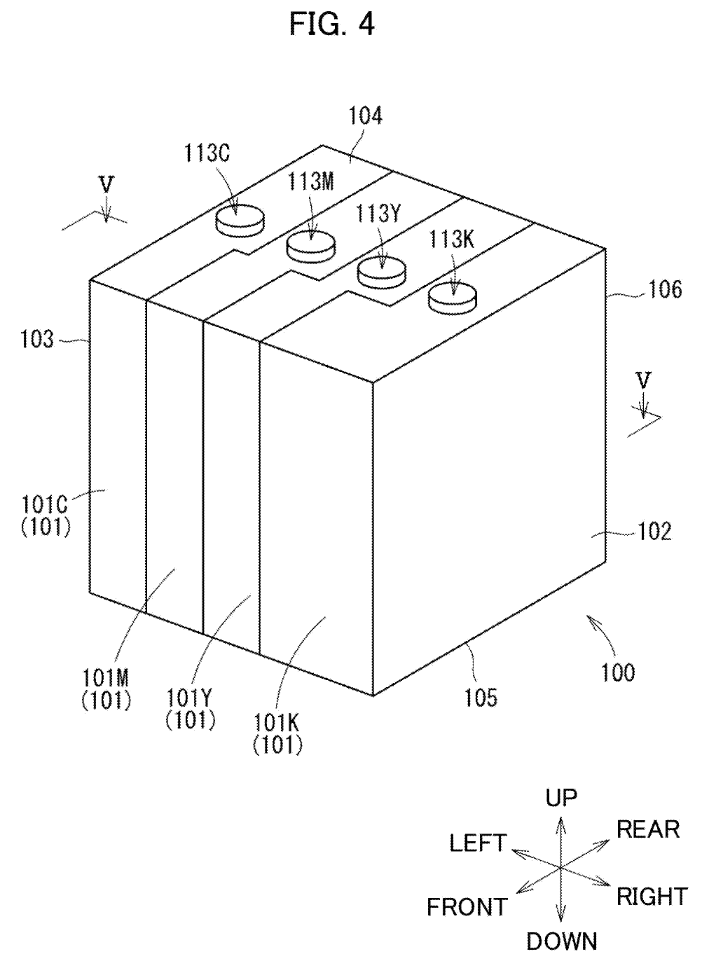

As illustrated in FIG. 4, the ink tank 100 has a substantially rectangular parallelepiped shape. The ink tank 100 has outer walls including the front wall 101, a right wall 102, a left wall 103, an upper wall 104, a lower wall 105, and a rear wall 106. The ink tank 100 is, for example, an integrally molded product formed by injection molding with resin. Among these outer walls of the ink tank 100, for example, the lower wall 105 may be formed as a separate molded part. The front wall 101, the right wall 102, the left wall 103, the upper wall 104, the lower wall 105, and the rear wall 106 are light transmissive to a degree such that a level of the ink stored in the ink tank 100 can be visually confirmed from outside the ink tank 100.

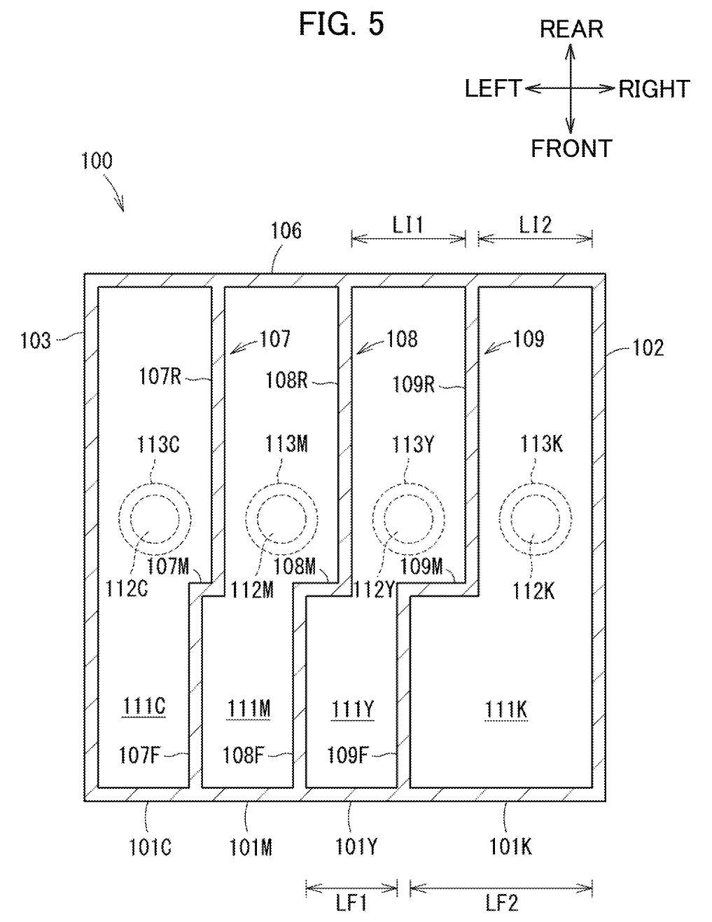

As illustrated in FIG. 5, the ink tank 100 has partition walls 107, 108, and 109 that partition an internal space of the ink tank 100 into four ink chambers 111. The four ink chambers 111 are aligned with one another in the left-right direction. In FIG. 4, parts corresponding to the partition walls 107, 108 and 109 defining the ink chambers 111 are shown by solid lines. However, these solid lines may not appear on an outer surface of the ink tank 100.

The four ink chambers 111 respectively store ink of four different colors, namely, cyan (C), magenta (M), yellow (Y), and black (K). The ink of yellow color is an example of “first liquid” of the disclosure, and the ink of black color is an example of “second liquid” of the disclosure.

Hereinafter, the four ink chambers 111 may be referred to as ink chambers 111C, 111M, 111Y, and 111K, as appropriate, according to the four colors of the ink stored in the respective ink chambers 111. Further, as a matter of convenience, portions of an inner surface of the front wall 101 defining the ink chambers 111C, 111M, 111Y, and 111K may be referred to as front walls 101C, 101M, 101Y, and 101K, respectively, in particular in FIGS. 4 through 12. A portion of the ink tank 100 defining the ink chamber 111Y is an example of “first tank” of the disclosure. A portion of the ink tank 100 defining the ink chamber 111K is an example of “second tank” of the disclosure. The ink chamber 111Y is an example of “first liquid chamber” of the disclosure. The ink chamber 111K is an example of “second liquid chamber” of the disclosure. The front wall 101Y is an example of “first wall” of the disclosure. The front wall 101K is an example of “second wall” of the disclosure.

The upper wall 104 of the ink tank 100 has four inlet ports 112 for supplying ink into the respective ink chambers 111. Each inlet port 112 extends through the upper wall 104, thereby allowing the corresponding ink chamber 111 to communicate with the outside of the ink tank 100. Specifically, an inlet port 112C is located in a portion of the upper wall 104 defining the ink chamber 111C. An inlet port 112M is located in a portion of the upper wall 104 defining the ink chamber 111M. An inlet port 112Y is located in a portion of the upper wall 104 defining the ink chamber 111Y. An inlet port 112K is located in a portion of the upper wall 104 defining the ink chamber 111K. The inlet port 112Y is an example of “first inlet port” of the disclosure. The inlet port 112K is an example of “second inlet port” of the disclosure. Each inlet port 112 need not be a through-hole, and may instead be configured as a tube, for example. In FIG. 5, positions of the inlet ports 112C, 112M, 112Y and 112K are depicted by broken lines.

The inlet port 112C is configured to be sealed by a cap 113C. The inlet port 112M is configured to be sealed by a cap 113M. The inlet port 112Y is configured to be sealed by a cap 113Y. The inlet port 112K is configured to be sealed by a cap 113K. The cap 113C is colored cyan. The cap 113M is colored magenta. The cap 113Y is colored yellow. The cap 113K is colored black. The cap 113Y is an example of “first cap” of the disclosure. The cap 113K is an example of “second cap” of the disclosure.

The inlet ports 112C, 112M, 112Y and 112K are arranged in a line in the left-right direction. The caps 113C, 113M, 113Y and 113K are also arranged in a line in the left-right direction. The inlet port 112C is located in a central region of the ink chamber 111C in the front-rear direction. The inlet port 112M is located in a central region of the ink chamber 111M in the front-rear direction. The inlet port 112Y is located in a central region of the ink chamber 111Y in the front-rear direction. The inlet port 112K is located in a central region of the ink chamber 111K in the front-rear direction. Each inlet port 112 is located at a generally left-right center of the region in the front-rear direction of the corresponding ink chamber 111 where the inlet port 112 is located.

The cap 113C has a circular shape in a plan view. When viewed from above, the cap 113C is positioned within a width of the ink chamber 111C in the left-right direction. The cap 113M has a circular shape in a plan view. When viewed from above, the cap 113M is positioned within a width of the ink chamber 111M in the left-right direction. The cap 113Y has a circular shape in a plan view. When viewed from above, the cap 113Y is positioned within a width of the ink chamber 111Y in the left-right direction. The cap 113K has a circular shape in a plan view. When viewed from above, the cap 113K is positioned within a width of the ink chamber 111K in the left-right direction. The caps 113C, 113M, 113Y and 113K have the same outer diameter as each other.

The caps 113C, 113M, 113Y and 113K are exposed to the outside of the multifunction peripheral 10 while the cover 70 is in the open position. By removing the caps 113C, 113M, 113Y and 113K, the inlet ports 112C, 112M, 112Y and 112K are exposed to the outside of the multifunction peripheral 10. In this state, by connecting nozzles of bottles storing ink of respective colors to the corresponding inlet ports 112C, 112M, 112Y and 112K, for example, ink can be supplied into the respective ink chambers 111C, 111M, 111Y and 111K.

Although not shown in the drawings, each of the ink chambers 111C, 111M, 111Y and 111K has an outlet port. Each outlet port is connected to a corresponding ink tube 32 to allow the ink in the corresponding ink chamber 111 to flow into the corresponding ink tube 32. Further, each of the ink chambers 111C, 111M, 111Y and 111K may have an air communication port to allow an interior of each ink chamber 111 to communicate with ambient air. Alternatively, each of the ink chambers 111C, 111M, 111Y and 111K may have a known detector configured to detect a level of the ink stored in the corresponding ink chamber 111.

As illustrated in FIG. 5, the partition walls 107, 108 and 109 are arranged inside the ink tank 100 to define the four ink chambers 111C, 111M, 111Y and 111K. The partition wall 107 is connected to the front wall 101, the upper wall 104, the lower wall 105, and the rear wall 106. The partition wall 107 is a partition between the ink chamber 111C and the ink chamber 111M. The partition wall 108 is connected to the front wall 101, the upper wall 104, the lower wall 105, and the rear wall 106. The partition wall 108 is a partition between the ink chamber 111M and the ink chamber 111Y. The partition wall 109 is connected to the front wall 101, the upper wall 104, the lower wall 105, and the rear wall 106. The partition wall 109 is a partition between the ink chamber 111Y and the ink chamber 111K.

The partition wall 107 has a crank shape in a top view. The partition wall 107 has a front part 107F, a middle part 107M, and a rear part 107R. The front part 107F is a flat plate extending in the up-down and front-rear direction directions. The front part 107F is connected to the front wall 101, the upper wall 104, and the lower wall 105. The middle part 107M is a flat plate extending in the up-down and left-right direction directions. The middle part 107M is connected to a rear end of the front part 107F. The middle part 107M is also connected to the upper wall 104 and the lower wall 105. The rear part 107R is a flat plate extending in the up-down and front-rear directions. The rear part 107R is connected to a right end of the middle part 107M. The rear part 107R is connected to the upper wall 104, the lower wall 105 and the rear wall 106.

The partition wall 108 has a crank shape in a top view. The partition wall 108 has a front part 108F, a middle part 108M, and a rear part 108R. The front part 108F is a flat plate extending in the up-down and front-rear direction directions. The front part 108F is connected to the front wall 101, the upper wall 104, and the lower wall 105. The middle part 108M is a flat plate extending in the up-down and left-right direction directions. The middle part 108M is connected to a rear end of the front part 108F. The middle part 108M is also connected to the upper wall 104 and the lower wall 105. The rear part 108R is a flat plate extending in the up-down and front-rear directions. The rear part 108R is connected to a right end of the middle part 108M. The rear part 108R is also connected to the upper wall 104, the lower wall 105 and the rear wall 106.

The partition wall 109 has a crank shape in a top view. The partition wall 109 has a front part 109F, a middle part 109M, and a rear part 109R. The front part 109F is a flat plate extending in the up-down and front-rear direction directions. The front part 109F is connected to the front wall 101, the upper wall 104, and the lower wall 105. The middle part 109M is a flat plate extending in the up-down and left-right direction directions. The middle part 109M is connected to a rear end of the front part 109F. The middle part 109M is also connected to the upper wall 104 and the lower wall 105. The rear part 109R is a flat plate extending in the up-down and front-rear directions. The rear part 109R is connected to a right end of the middle part 109M. The rear part 109R is also connected to the upper wall 104, the lower wall 105 and the rear wall 106.

With respect to the left-right direction, dimensions of the middle part 107M of the partition wall 107, the middle part 108M of the partition wall 108, and the middle part 109M of the partition wall 109 are mutually different. Specifically, among these three middle parts 107M, 108M and 109M, the middle part 107M of the partition wall 107 has a smallest dimension in the left-right direction, while the middle part 109M of the partition wall 109 has a largest dimension in the left-right direction. Further, among the four ink chambers 111, the ink chamber 111K has a largest volume. The ink chamber 111C, the ink chamber 111M, and the ink chamber 111Y have the same volume as each other. Accordingly, the volume of the ink chamber 111K is greater than the volume of the ink chamber 111Y.

The “volume” of each ink chamber 111 may refer to the total volume of the ink chamber 111, or to the maximum volume of ink that can be stored in the ink chamber 111. Alternatively, the “volume” of each ink chamber 111 may refer to a difference in volume between the maximum amount of ink that can be stored in the ink chamber 111 and the minimum amount of ink in the ink chamber 111 that is required to perform printing. The maximum amount and minimum amount may be indicated respectively by indicators such as horizontal lines. These indicators may be provided on the front wall 101, or on the transparent member 71 of the cover 70. The volume of the ink chamber 111Y is an example of “first volume” of the disclosure. The volume of the ink chamber 111K is an example of “second volume” of the disclosure.

The ink chamber 111C is located at the left end of the ink tank 100 in the left-right direction. The ink chamber 111C stores ink of the color of cyan. The ink chamber 111M is located to the right of the ink chamber 111C in the left-right direction. The ink chamber 111M stores ink of the color of magenta. The ink chamber 111Y is located to the right of the ink chamber 111M. The ink chamber 111Y stores ink of the color of yellow. The ink chamber 111K is located at the right end of the ink tank 100 in the left-right direction. The ink chamber 111K stores ink of the color of black. In other words, the ink chamber 111K is positioned closer to a right end of the housing 14 in the left-right direction than the ink chamber 111Y is to the right end of the housing 14.

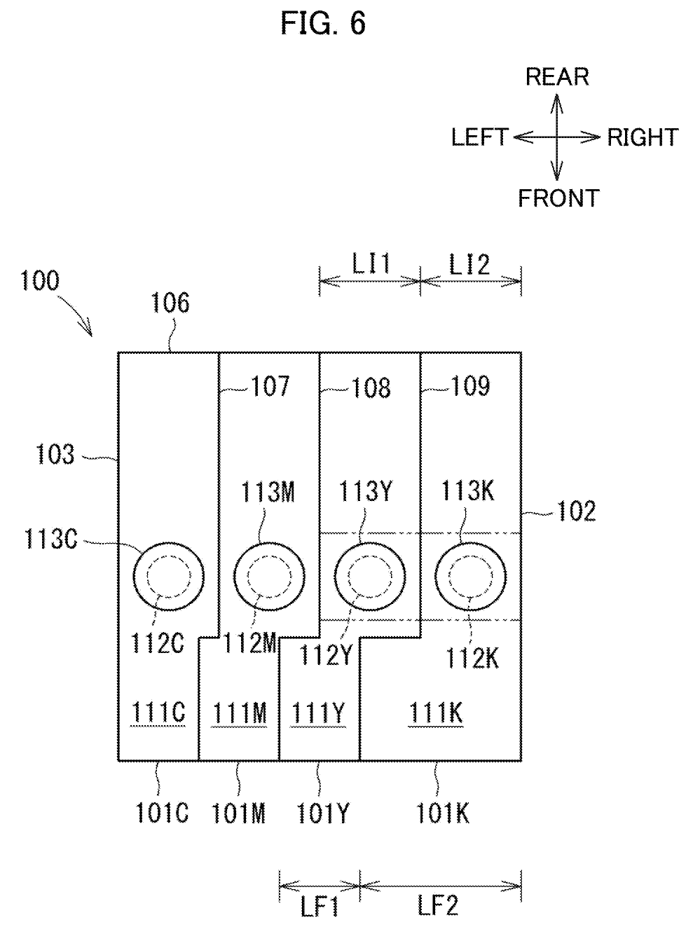

As illustrated in FIG. 6, the front wall 101Y has a dimension LF1 in the left-right direction that is smaller than a dimension LF2 of the front wall 101K in the left-right direction. As illustrated in FIG. 5, the dimension LF1 is a dimension in the left-right direction of the front wall 101Y that defines the ink chamber 111Y. The dimension LF2 is a dimension in the left-right direction of the front wall 101K that defines the ink chamber 111K. In the present embodiment, the dimension in the left-right direction of the front wall 101C is equal to the dimension LF1, and the dimension in the left-right direction of the front wall 101M is equal to the dimension LF1. A ratio of the dimension LF1 to the dimension LF2 is equal to a ratio of the volume of the ink chamber 111Y to the volume of the ink chamber 111K. The dimension LF1 is an example of “first dimension” of the disclosure, and the dimension LF2 is an example of “second dimension” of the disclosure.

The dimension LF1 is smaller than a dimension LI1 in the left-right direction of a portion of the ink chamber 111Y where the inlet port 112Y is located. A portion of the ink chamber 111K where the inlet port 112K is located has a dimension LI2 in the left-right direction that is smaller than the dimension LF2. The dimension LI1 and the dimension LI2 are equal to each other. The dimension LI1 is smaller than twice the outer diameter of the cap 113Y. The dimension LI2 is smaller than twice the outer diameter of the cap 113K.

The inlet port 112Y of the ink chamber 111Y is located in a region indicated by two-dotted lines in FIG. 6. The inlet port 112K of the ink chamber 111K is located in a region also indicated by two-dotted lines in FIG. 6. The dimension LI1 is an example of “fourth dimension” of the disclosure. The dimension LI2 is an example of “third dimension” of the disclosure. The region in the front-rear direction of the ink chamber 111Y where the inlet port 112Y is located is an example of “specific region of the first liquid chamber” of the disclosure. The region in the front-rear direction of the ink chamber 111K where the inlet port 112K is located is an example of “specific region of the second liquid chamber” of the disclosure.

### Technical Advantages of the First Embodiment

A user can intuitively recognize that the volume of the ink chamber 111K is greater than the volume of the ink chamber 111Y by just looking at the dimensions LF1 and LF2 of the front walls 101Y and 101K of the ink tank 100 from the outside.

Since the dimension LI2 of the ink chamber 111K is smaller than the dimension LF2 of the front wall 101K, the ink chamber 111Y and ink chamber 111K obviates the need to occupy a larger space (larger dimension) in the left-right direction inside the housing 14 than otherwise.

Since the dimension LF1 of the front wall 101Y is smaller than the dimension LI1 of the ink chamber 111Y, the ink chamber 111Y and ink chamber 111K obviates the need to occupy a larger space (larger dimension) in the left-right direction inside the housing 14 than otherwise.

### First Modification to the First Embodiment

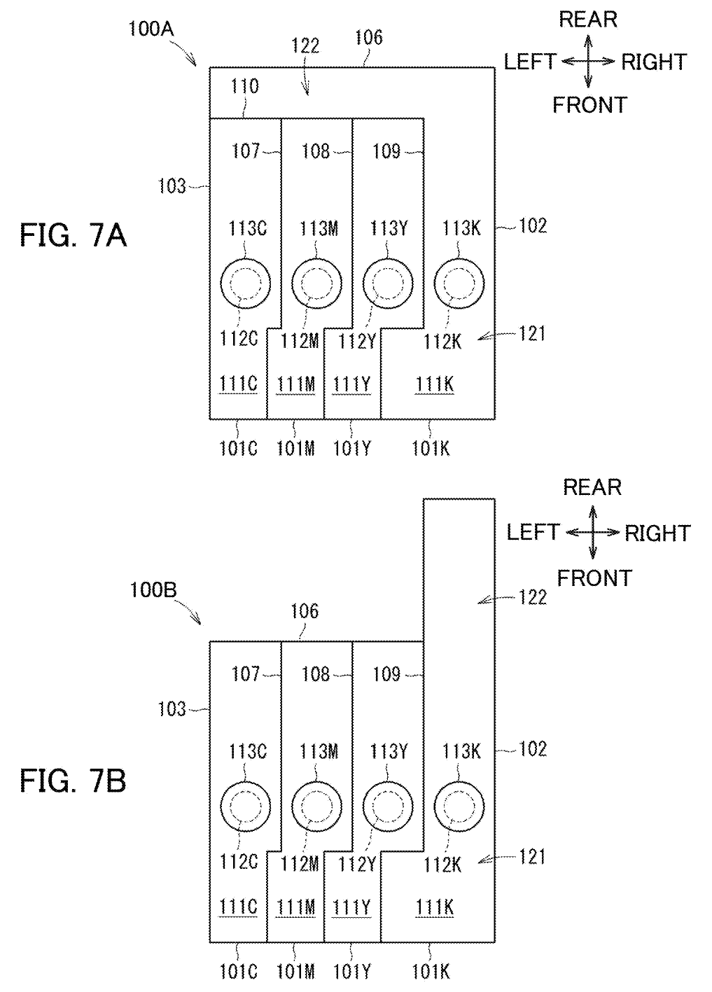

In the first embodiment described above, the rear end of the ink chamber 111K is aligned with (in flush with) the rear end of the ink chamber 111Y. However, as illustrated in FIG. 7A, the ink chamber 111K may extend further rearward relative to the ink chamber 111Y.

Specifically, FIG. 7A illustrates an ink tank 100A according to a first modification to the first embodiment. Referring to FIG. 7A, in the ink tank 100A according to this first modification, the ink chamber 111K is a space defined by the front wall 101K, the right wall 102, the upper wall 104, the lower wall 105, the rear wall 106, the partition wall 109, and a partition wall 110. The ink chamber 111K has an L-shape when viewed from above.

The rear end of the ink chamber 111K is located rearward of the respective rear ends of the ink chambers 111C, 111M and 111Y. The ink chamber 111K has a first space 121, and a second space 122 located rearward of the first space 121. The first space 121 is a frontward space defined by the front wall 101K, the right wall 102, the upper wall 104, the lower wall 105, and the partition wall 109. No wall defines a rear end of the first space 121. The first space 121 and the ink chamber 111Y are arranged adjacent to each other in the left-right direction. In other words, the ink chamber 111Y is located between the ink chamber 111M and the first space 121 in the left-right direction. The first space 121 has a length in the front-rear direction that is identical to a length in the front-rear direction of each of the ink chambers 111C, 111M and 111Y (assuming that a thickness of the partition wall 110 is not considered). The partition walls 107, 108 and 109 are not connected to the rear wall 106, but are connected to the partition wall 110 extending in the left-right direction.

The second space 122 is located adjacent to and rearward of the first space 121. The first space 121 and the second space 122 are in communication with each other. The second space 122 is defined by the right wall 102, the upper wall 104, the lower wall 105, the rear wall 106, the left wall 103, and the partition wall 110. The second space 122 is located adjacent to and rearward of each of the ink chambers 111C, 111M, and 111Y. The second space 122 extends in the left-right direction rearward of both the first space 121 and the first liquid chamber 111Y.

When viewed in the front-rear direction, the second space 122 extends in the left-right direction to span between left and right ends of the rear end of the ink chamber 111Y. That is, the partition wall 110 that defines the second space 122 also defines the rear ends of the ink chambers 111C, 111M and 111Y.

### Second Modification to the First Embodiment

The ink chamber 111K may have an I-shape as illustrated in FIG. 7B, rather than the L-shape illustrated in FIG. 7A.

Specifically, FIG. 7B illustrates an ink tank 100B according to a second modification to the first embodiment. As illustrated in FIG. 7B, the second space 122 is not located rearward of the ink chamber 111Y. The ink chamber 111K has a rear end that is located rearward of the rear end of the ink chamber 111Y in the front-rear direction.

### Third Modification to the First Embodiment

The partition walls 107, 108, and 109 in the ink tank 100 according to the first embodiment may be configured as plates straightly extending in the up-down and front-rear directions, rather than the crank shaped plates.

Specifically, FIG. 8 illustrates an ink tank 100C according to a third modification to the first embodiment. In the ink tank 100C according to this third modification, the right wall 102 has a crank shape. Due to this crank shaped right wall 102, the ink chamber 111K has a larger volume than the ink chamber 111Y. Further, the dimension LF1 of the front wall 101Y is smaller than the dimension LF2 of the front wall 101K.

In this third modification, the housing 14 has a side panel 14S constituting a right side surface of the housing 14. The side panel 14S has a front end 14SF located rearward of the front wall 101K. Due to the crank-shaped right wall 102, the dimension LI2 in the left-right direction of the region in the front-rear direction of the ink chamber 111K where the inlet port 112K is located is smaller than the dimension LF2 in the left-right direction of the front wall 101K. Hence, a space is formed in a region rightward of and rearward of the region in the front-rear direction of the ink chamber 111K where the inlet port 112K is located. In this space, the front end 14SF of the side panel 14S is connected to the frame 17 of the printer portion 11. In this way, the space on the right of the ink chamber 111K can be effectively utilized.

In the ink tank 100 of the first embodiment, the cover 70 is disposed for covering the front surface of the ink tank 100. The cover 70 of the first embodiment is an example of “front panel” of the disclosure. Alternatively, the cover 70 may be omitted, and a front panel may be arranged as the front surface of the housing 14.

### Fourth Modification to the First Embodiment

In the above-described ink tanks 100, 100A, 100B, and 100C, the position of the inlet port 112 relative to the corresponding ink chamber 111 is constant among the four ink chambers 111. That is, the inlet port 112 is located at a generally left-right center of the region in the front-rear direction of each ink chamber 111 where the inlet port 112 is located. However, the positional relationship between each inlet port 112 and its corresponding ink chamber 111 need not be limited to that in the first embodiment.

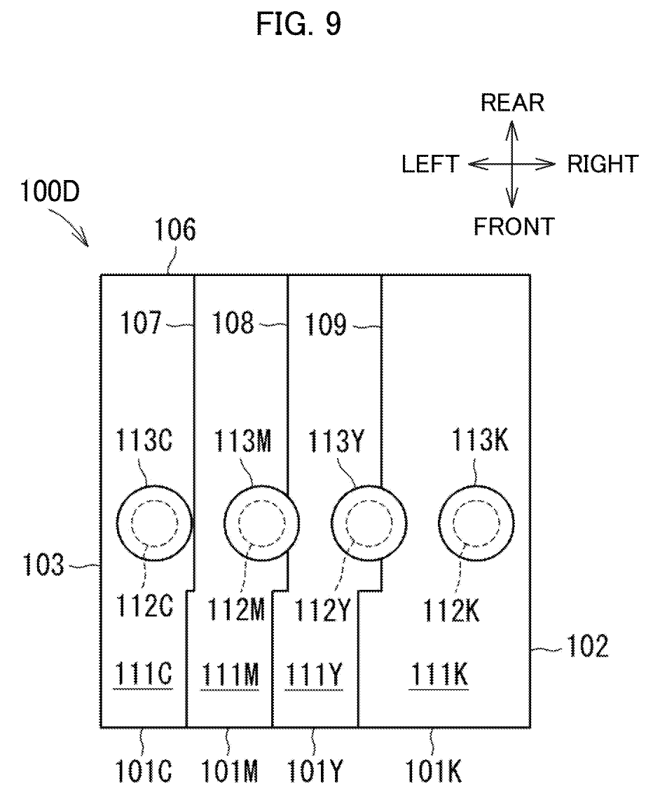

As an alternative configuration, FIG. 9 illustrates an ink tank 100D according to a fourth modification to the first embodiment. In this ink tank 100D according to the fourth modification, the inlet port 112C in the ink chamber 111C is located to the right of the center in the left-right direction of the ink chamber 111C. The inlet port 112M of the ink chamber 111M is located also to the right of the center in the left-right direction of the ink chamber 111M.

The inlet port 112Y of the ink chamber 111Y is located also to the right of the center in the left-right direction of the ink chamber 111Y. The inlet port 112K of the ink chamber 111K is located to the right of the center in the left-right direction of the ink chamber 111K.

With this configuration, the inlet ports 112C, 112M, 112Y and 112K of the ink tank 100D can be arranged at equal intervals regardless of the different dimensions in the left-right direction of the respective ink chambers 111C, 111M, 111Y and 111K.

### Second Embodiment

In the ink tank 100 of the first embodiment, the front wall 101 is visible in its entirety in the left-right direction through the transparent member 71 of the cover 70. However, alternatively, the front wall 101 may be covered by a cover.

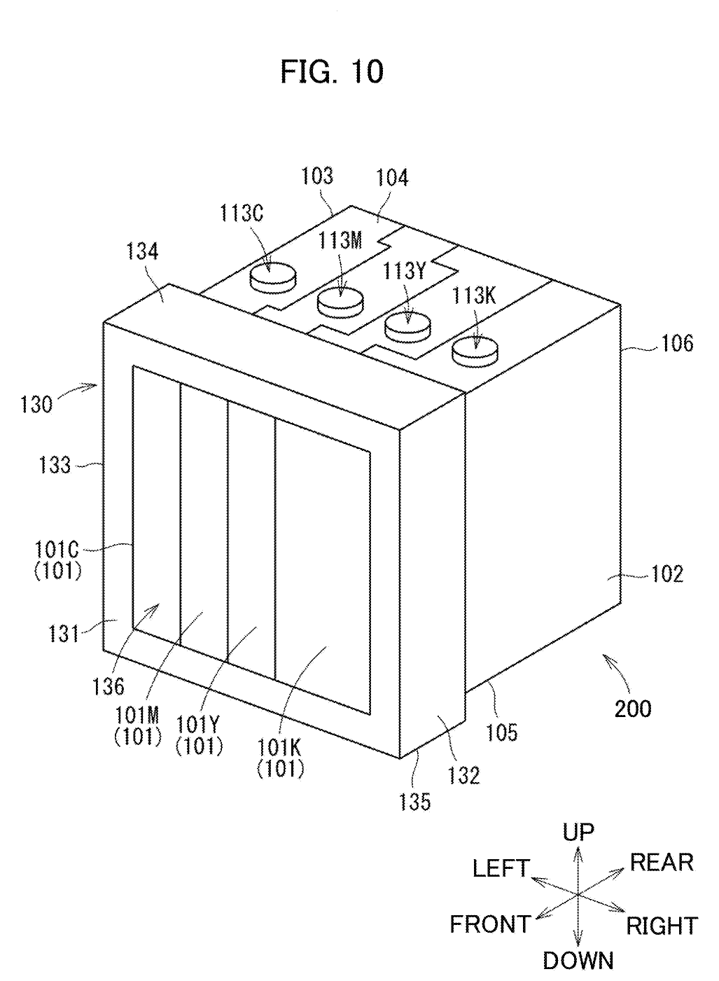

Referring to FIG. 10, an ink tank 200 according to a second embodiment of the disclosure includes a tank cover 130 for covering the front wall 101. The ink tank 200 and the tank cover 130 are both fixed to the housing 14. A portion of the ink tank 200 defining the ink chamber 111Y is another example of “first tank” of the disclosure. A portion of the ink tank 200 defining the ink chamber 111K is another example of “second tank” of the disclosure. The tank cover 130 is an example of “cover” of the disclosure.

Specifically, as illustrated in FIG. 10, the tank cover 130 has a box shape that is open rearward. The tank cover 130 includes a front wall 131, a right wall 132, a left wall 133, an upper wall 134, and a lower wall 135. The tank cover 130 covers the front wall 101 of the ink tank 200. The tank cover 130 also covers a part of the right wall 132, a part of the left wall 133, a part of the upper wall 134, and a part of the lower wall 135.

The tank cover 130 may cover all areas of these walls 132, 133, 134 and 135. In this case, through-hole(s) may be formed in the upper wall 134 so that the inlet ports 112C, 112M, 112Y and 112K are accessible through the through-hole(s).

The front wall 131 of the tank cover 130 has a light-transmissive part 136. The light-transmissive part 136 has such a translucency that the front wall 101 of the ink tank 200 is visible through the light-transmissive part 136. The light-transmissive part 136 may be simply a through-hole extending through the front wall 131 in the front-rear direction, or a transparent member fitted in the through-hole. The light-transmissive part 136 has a rectangular shape in a front view. A remaining part of the front wall 131 other than the light-transmissive part 136 is not light transmissive and thus constitutes a non-transmissive part. When the tank cover 130 is viewed from the front side, an area of the front wall 101 is visible through the light-transmissive part 136.

Here, the “area of the front wall 101 that is visible through the light-transmissive part 136” means an area of the front wall 101 that does not overlap the non-transmissive part of the front wall 131 when the front wall 101 is projected onto the front wall 131 of the tank cover 130 in a direction orthogonal to the front wall 101. Specifically, the “area of the front wall 101K that is visible through the light-transmissive part 136” denotes an area of the front wall 101K that does not overlap the non-transmissive part of the front wall 131 when the front wall 101K is projected onto the front wall 131 of the tank cover 130 in the direction orthogonal to the front wall 101K. The same applies to the front walls 101C, 101M, and 101Y.

With respect to the front wall 101Y of the ink chamber 111Y, an entire area thereof in the left-right direction is visible through the light-transmissive part 136 when the front wall 101Y is viewed in the direction orthogonal to the front wall 101. With respect to the front wall 101K of the ink chamber 111K, only a leftward area thereof in the left-right direction is visible through the light-transmissive part 136 (a right end area thereof is covered by the non-transmissive part of the front wall 131 and thus is not visible when viewed in the front-rear direction).

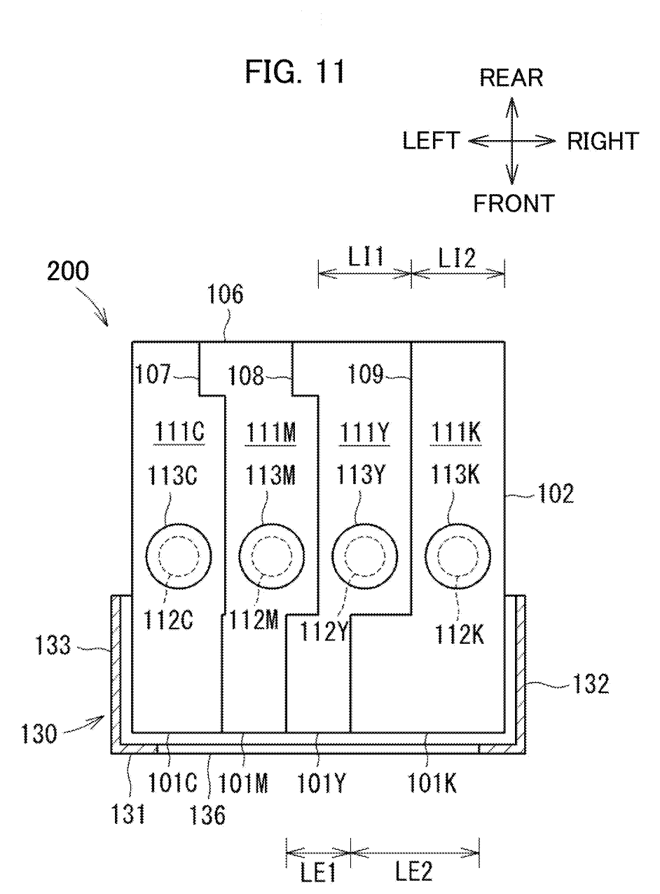

Referring to FIG. 11, a dimension LE1 is defined as a dimension in the left-right direction of the area of the front wall 101Y that is visible through the light-transmissive part 136. That is, the dimension LE1 is also defined as a left-right dimension of the front wall 101Y defining the ink chamber 111Y. A dimension LE2 is defined as a dimension in the left-right direction of the area of the front wall 101K that is visible through the light-transmissive part 136. That is, the dimension LE2 is also defined as a left-right dimension of the area of the front wall 101K that is visible through the light-transmissive part 136, the area being defined as an area in the left-right direction between a left end of the front wall 101K and a right end of the light-transmissive part 136. With respect to the ink chamber 111Y, a dimension LI1 is defined as a left-right dimension of a region of the ink chamber 111Y where the inlet port 112Y is located. With respect to the ink chamber 111K, a dimension LI2 is defined as a left-right dimension of a region of the ink chamber 111K where the inlet port 112K is located.

The dimension LE1 is smaller than the dimension LE2. The dimension LI1 and the dimension LI2 are equal to each other. The dimension LE1 is smaller than the dimension LI1.

The dimension LE1 is another example of “first dimension” of the disclosure. The dimension LE2 is another example of “second dimension” of the disclosure. The dimension LI1 is an example of “fourth dimension” of the disclosure. The dimension LI2 is an example of “third dimension” of the disclosure. The area of the front wall 101Y that is visible through the light-transmissive part 136 is an example of “first area” of the disclosure. The area of the front wall 101K that is visible through the light-transmissive part 136 is an example of “second area” of the disclosure.

The volume of the ink chamber 111Y is smaller than the volume of the ink chamber 111K. In the second embodiment, a portion of the front wall 101C and a portion of the front wall 101K are covered by the non-transmissive part of the front wall 131 of the tank cover 130 and are thus not visible through the light-transmissive part 136 of the tank cover 130. Hence, when the ink tank 200 is viewed from the front side, the left-right dimension of the front wall 101C (precisely, the left-right dimension of the area of the front wall 101C that is visible through the light-transmissive part 136) is neither equal to the left-right dimension of the front wall 101M nor to the left-right dimension of the front wall 101Y. The volume of the ink chamber 111C, the volume of the ink chamber 111M, and the volume of the ink chamber 111Y are equal to each other. That is, the shapes of the partition walls 107, 108, and 109 are different from those in the first embodiment.

### Technical Advantages of the Second Embodiment

In the ink tank 200 according to the second embodiment, a user can intuitively recognize the difference in volume between the ink chamber 111Y and the ink chamber 111K simply by looking at the dimension LE1 of the front wall 101Y and the dimension LE2 of the front wall 101K through the light-transmissive part 136 of the tank cover 130.

Further, the dimension LE1 of the front wall 101Y is smaller than the dimension LI1 of the ink chamber 111Y. Hence, the ink chamber 111Y and the ink chamber 111K obviates the need to occupy a larger space inside the housing 14 in the left-right direction than otherwise.

### First Modification to the Second Embodiment

In the second embodiment, the light-transmissive part 136 of the tank cover 130 is a single continuous piece. However, the light-transmissive part 136 of the tank cover 130 may be divided into four separate pieces.

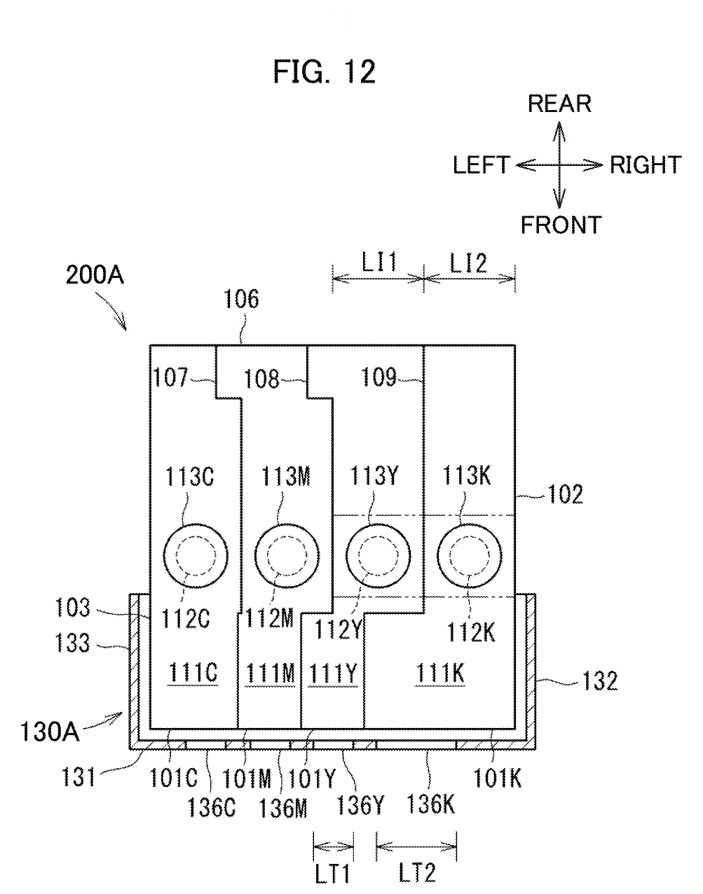

Specifically, FIG. 12 illustrates an ink tank 200A including a tank cover 130A according to a first modification to the second embodiment. Referring to FIG. 12, the front wall 131 of the tank cover 130A has four light-transmissive parts: a light-transmissive part 136C, a light-transmissive part 136M, a light-transmissive part 136Y, and a light-transmissive part 136K. The light-transmissive part 136Y is an example of “first light-transmissive part” of the disclosure. The light-transmissive part 136K is an example of “second light-transmissive part” of the disclosure.

The light-transmissive part 136C has a rectangular shape elongated in the up-down direction and having a greater dimension in the up-down direction than in the left-right direction. Through the light-transmissive part 136C, a part of the front wall 101C is visible from the outside.

The light-transmissive part 136M has a rectangular shape elongated in the up-down direction and having a greater dimension in the up-down direction than in the left-right direction. Through the light-transmissive part 136M, a part of the front wall 101M is visible from the outside.

The light-transmissive part 136Y has a rectangular shape elongated in the up-down direction and having a greater dimension in the up-down direction than in the left-right direction. Through the light-transmissive part 136Y, a part of the front wall 101Y is visible from the outside.

The light-transmissive part 136K has a rectangular shape elongated in the up-down direction and having a greater dimension in the up-down direction than in the left-right direction. Through the light-transmissive part 136K, a part of the front wall 101K is visible from the outside.

Here, a dimension in the left-right direction of the light-transmissive part 136Y is defined as a dimension LT1. A dimension in the left-right direction of the light-transmissive part 136K is defined as a dimension LT2. The dimension LT1 is smaller than the dimension LT2. The dimension LI1 and the dimension LI2 are equal to each other, as in the second embodiment. The dimension LT1 is smaller than the dimension LI1 (and the dimension LI2). The dimension LT1 is another example of “first dimension” of the disclosure. The dimension LT2 is another example of “second dimension” of the disclosure.

### Other Modifications to the Second Embodiment

In the ink tank 200 according to the second embodiment, the ink chamber 111K may be formed to have an L-shape (as illustrated in FIG. 7A) or an I-shape (as illustrated in FIG. 7B) when viewed from above. Still alternatively, the right wall 102 of the ink tank 200 may be formed to have a crank shape, as illustrated in FIG. 8.

### Other Modifications to the First and Second Embodiments

In the first and second embodiments described above, the ink tank 100, 200 is arranged at a right end in the interior space of the housing 14. However, the ink tank 100, 200 may be arranged in a left end in the interior space of the housing 14. Alternatively, the ink tank 100, 200 may be arranged at a position offset from the center of the housing 14 in the left-right direction, either toward the right or toward the left. Still alternatively, the ink tank 100, 200 may be arranged so as not to be visible on the front surface of the housing 14. For example, the ink tank 100, 200 may be arranged so as to be visible on a left or right side surface of the housing 14.

The ink tank 100, 200 may not have four ink chambers 111. For example, the ink tank 100, 200 may only have the ink chambers 111Y and 111K. In this case, another ink tank having the ink chambers 111C and 111M may be arranged in a different location from the ink tank 100, 200 (having the ink chambers 111Y, 111K) in the interior space of the housing 14. For example, the ink tank 100, 200 having the ink chambers 111Y and 111K may be arranged at the right end in the interior space of the housing 14, while the other tank having the ink chambers 111C and 111M may be arranged at the left end in the interior space of the housing 14. Still alternatively, the cover 70 may be omitted from the housing 14.

The ink tank 100, 200 may not be formed as a single member (as an integrally-molded product). For example, an ink tank having the ink chamber 111Y and another ink tank having the ink chamber 111K may be formed as separate members (as two separate molded products).

Further, the types of liquid stored in the respective ink chambers 111 may be distinguished by ink compositions, rather than by ink colors. Further, the “liquid” of the disclosure need not be ink, but may be pretreatment liquid (which is to be ejected onto a sheet prior to ejection of ink for printing) or preservation liquid (which is to be sprayed onto a region near the nozzles 40 of the recording head 39 for protection against desiccation of the nozzles 40).

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents.

What is claimed is:

1. A liquid consuming device comprising:
a housing;
a liquid consuming part;
a first tank arranged inside the housing, the first tank including:
a first liquid chamber configured to store first liquid to be supplied to the liquid consuming part, the first liquid chamber having a first volume;
a first wall through which a liquid level of the first liquid stored in the first liquid chamber is visible, the first wall defining the first liquid chamber; and
a first inlet port providing communication between the first liquid chamber and an outside of the first tank; and
a second tank arranged inside the housing, the first tank and the second tank being arranged in a left-right direction, the second tank including:
a second liquid chamber configured to store second liquid to be supplied to the liquid consuming part, the second liquid chamber having a second volume;
a second wall through which a liquid level of the second liquid stored in the second liquid chamber is visible, the second wall defining the second liquid chamber; and
a second inlet port providing communication between the second liquid chamber and an outside of the second tank,
wherein
the first volume of the first liquid chamber is smaller than the second volume of the second liquid chamber,
the first wall has a first dimension in the left-right direction that is smaller than a second dimension of the second wall in the left-right direction, and
the second liquid chamber has a specific region where the second inlet port is located, the specific region of the second liquid chamber having a third dimension in the left-right direction that is smaller than the second dimension.

2. The liquid consuming device according to claim 1,
wherein the first liquid chamber has a specific region where the first inlet port is located, the specific region of the first liquid chamber having a fourth dimension in the left-right direction, and
wherein the first dimension of the first wall is smaller than the fourth dimension of the specific region of the first liquid chamber.

3. The liquid consuming device according to claim 2,
wherein the third dimension of the specific region of the second liquid chamber is equal to the fourth dimension of the specific region of the first liquid chamber.

4. The liquid consuming device according to claim 2, further comprising:
a first cap for sealing the first inlet port, the first cap having an outer diameter; and
a second cap for sealing the second inlet port, the second cap having an outer diameter,
wherein
the third dimension of the specific region of the second liquid chamber is smaller than twice the outer diameter of the second cap, and
the fourth dimension of the specific region of the first liquid chamber is smaller than twice the outer diameter of the first cap.

5. The liquid consuming device according to claim 1,
wherein a ratio of the first dimension of the first wall to the second dimension of the second wall is equal to a ratio of the first volume of the first liquid chamber to the second volume of the second liquid chamber.

6. The liquid consuming device according to claim 1, further comprising:
a cover for covering the first wall of the first tank and the second wall of the second tank, the cover having:
a first light-transmissive part through which the first wall is visible; and
a second light-transmissive part through which the second wall is visible, the second light-transmissive part having a dimension in the left-right direction that is greater than a dimension of the first light-transmissive part in the left-right direction.

7. The liquid consuming device according to claim 1, further comprising:
a first cap for sealing the first inlet port, the first cap being colored in a color other than black; and
a second cap for sealing the second inlet port, the second cap being colored in black.

8. The liquid consuming device according to claim 1,
wherein the first tank and the second tank are formed as a single member.

9. The liquid consuming device according to claim 1,
wherein the housing has an end in the left-right direction,
wherein the first tank and the second tank are positioned offset from a center of the housing in the left-right direction, and
wherein the second tank is positioned closer to the end of the housing in the left-right direction than the first tank is to the end of the housing in the left-right direction.

10. A liquid consuming device comprising:
a housing;
a liquid consuming part;
a first tank arranged inside the housing, the first tank including:
a first liquid chamber configured to store first liquid to be supplied to the liquid consuming part, the first liquid chamber having a first volume;
a first wall through which a liquid level of the first liquid stored in the first liquid chamber is visible, the first wall defining the first liquid chamber; and
a first inlet port providing communication between the first liquid chamber and an outside of the first tank; and
a second tank arranged inside the housing, the first tank and the second tank being arranged in a left-right direction, the second tank including:
a second liquid chamber configured to store second liquid to be supplied to the liquid consuming part, the second liquid chamber having a second volume;
a second wall through which a liquid level of the second liquid stored in the second liquid chamber is visible, the second wall defining the second liquid chamber; and
a second inlet port providing communication between the second liquid chamber and an outside of the second tank,
wherein
the first volume of the first liquid chamber is smaller than the second volume of the second liquid chamber,
the first wall has a first area visible from an outside of the housing and the second wall has a second area visible from the outside of the housing, the first area having a first dimension in the left-right direction that is smaller than a second dimension of the second area in the left-right direction,
the second liquid chamber has a specific region where the second inlet port is located, the specific region of the second liquid chamber having a third dimension in the left-right direction, and
the first liquid chamber has a specific region where the first inlet port is located, the specific region of the first liquid chamber having a fourth dimension in the left-right direction that is equal to the third dimension.

11. The liquid consuming device according to claim 10,
wherein the first dimension of the first wall is smaller than the third dimension of the specific region of the second liquid chamber.

12. The liquid consuming device according to claim 10,
wherein the first dimension is a dimension of the first wall in the left-right direction, and
wherein the second dimension is a dimension of the second wall in the left-right direction.

13. The liquid consuming device according to claim 12,
wherein the housing has an end in the left-right direction,
wherein the second tank is positioned closer to the end of the housing in the left-right direction than the first tank is to the end of the housing,
wherein the second tank further includes a rear wall in the front-rear direction, the rear wall having one end and an other end in the left-right direction, the one end of the rear wall being closer to the end of the housing in the left-right direction than the other end of the rear wall is to the end of the housing,
wherein the second wall is a front wall of the second tank, the second wall having one end and an other end in the left-right direction, the one end of the second wall being closer to the end of the housing in the left-right direction than the other end of the second wall is to the end of the housing in the left-right direction, and
wherein the one end of the second wall is closer to the end of the housing in the left-right direction than the one end of the rear wall is to the end of the housing in the left-right direction.

14. The liquid consuming device according to claim 13,
wherein the housing includes:
a front panel covering the first wall of the first tank and the second wall of the second tank; and
a side panel constituting the end of the housing in the left-right direction, the side panel having a front end that is located rearward of the second wall in the front-rear direction.

15. The liquid consuming device according to claim 10, further comprising:
a cover for covering the first wall of the first tank and the second wall of the second tank, the cover having:
a first light-transmissive part through which the first wall is visible; and
a second light-transmissive part through which the second wall is visible,
wherein the first dimension of the first wall is equal to a dimension of the first light-transmissive part in the left-right direction, and
wherein the second dimension of the second wall is equal to a dimension of the second light-transmissive part in the left-right direction.

16. The liquid consuming device according to claim 10, further comprising:
a cover for covering the first wall of the first tank and the second wall of the second tank, the cover having a light-transmissive part through which both the first wall and the second wall are visible,
wherein the first area is an area of the first wall visible through the light-transmissive part, and
wherein the second area is an area of the second wall visible through the light-transmissive part.

17. The liquid consuming device according to claim 10,
wherein the second liquid chamber has:
a first space defined at least by the second wall, the first space and the first liquid chamber being arranged in the left-right direction; and
a second space in communication with the first space, the second space extending in the left-right direction rearward of both the first space and the first liquid chamber.

18. The liquid consuming device according to claim 10,
wherein the second liquid chamber has a rear end that is located rearward of a rear end of the first liquid chamber in the front-rear direction.

19. The liquid consuming device according to claim 10, further comprising:
a first cap for sealing the first inlet port, the first cap being colored in a color other than black; and
a second cap for sealing the second inlet port, the second cap being colored in black.

20. The liquid consuming device according to claim 10,
wherein the first tank and the second tank are formed as a single member.

21. The liquid consuming device according to claim 10,
wherein the housing has an end in the left-right direction,
wherein the first tank and the second tank are positioned offset from a center of the housing in the left-right direction, and
wherein the second tank is positioned closer to the end of the housing in the left-right direction than the first tank is to the end of the housing in the left-right direction.

22. A liquid consuming device comprising:
a housing;
a liquid consuming part;
a first tank arranged inside the housing, the first tank including:
a first liquid chamber configured to store first liquid to be supplied to the liquid consuming part, the first liquid chamber having a first volume;
a first wall through which a liquid level of the first liquid stored in the first liquid chamber is visible, the first wall defining the first liquid chamber; and
a first inlet port providing communication between the first liquid chamber and an outside of the first tank; and
a second tank arranged inside the housing, the first tank and the second tank being arranged in a left-right direction, the second tank including:
a second liquid chamber configured to store second liquid to be supplied to the liquid consuming part, the second liquid chamber having a second volume;
a second wall through which a liquid level of the second liquid stored in the second liquid chamber is visible, the second wall defining the second liquid chamber; and
a second inlet port providing communication between the second liquid chamber and an outside of the second tank,
wherein
the first volume of the first liquid chamber is smaller than the second volume of the second liquid chamber,
the first wall has a first area visible from an outside of the housing and the second wall has a second area visible from the outside of the housing, the first area having a first dimension in the left-right direction and the second area having a second dimension in the left-right direction, and
a ratio of the first dimension to the second dimension is equal to a ratio of the first volume to the second volume.
